(19) United States
(12) Patent Application Publication
(10) Pub. No.: US 2012/0138012 A1
(43) Pub. Date: Jun. 7, 2012

(54) DIRECT ACTING CDA DEVICE

(75) Inventor: Myungsik Choi, Seoul (KR)

(73) Assignees: Kia Motors Corporation, Seoul (KR); Hyundai Motor Company, Seoul (KR)

(21) Appl. No.: 13/236,455

(22) Filed: Sep. 19, 2011

(30) Foreign Application Priority Data
Dec. 3, 2010 (KR) 10-2010-0123059

(51) Int. Cl. F02D 17/02

(52) U.S. Cl. 123/198 F

(57) ABSTRACT

A direct acting CDA device may include an outer body glidingly contacting a cam and moving up and down, an hollow upper seat located in the outer body and restricted to the movement of the outer body, an oil passage formed between the outer body and the upper seat, a latching device insertion hole formed in a transverse direction in the oil passage, an hollow inner body located in the upper seat, latching devices inserted in the latching device insertion hole and selectively restricting the movement of the inner body to the movement of the outer body by selective oil supply, and a lost motion spring located in the hollow spaces of the upper seat and the inner body, supported by the inner body and providing the outer body with an elastic force so that the outer body can selectively take a lost motion.

### CROSS-REFERENCE TO RELATED APPLICATION

The present application claims priority of Korean Patent Application Number 10-2010-0123059 filed in the Korean Intellectual Property Office on Dec. 3, 2010, the entire contents of which application is incorporated herein for all purposes by this reference.

### BACKGROUND OF THE INVENTION

1. Field of Invention

The present invention relates to a direct acting cylinder deactivation (CDA) device. More particularly, the present invention relates to a direct acting CDA device in which the movement of an inner body is subjected to the movement of an outer body by engaging latching devices in both sides of an upper seat, and selectively supplying oil.

2. Description of Related Art

Generally, an internal combustion engine generates power by burning fuel and air drawn into a combustion chamber. Intake valves are operated by a camshaft, and air is drawn into the combustion chamber when the intake valves are open. Also, exhaust valves are operated by the camshaft, and combusted mixed gas is exhausted from the combustion chamber when the exhaust valves are open. Optimal operation of the intake valves/exhaust valves depends on the engine speed. That is, an appropriate lift or an appropriate opening/closing time depends on the engine speed.

In order to achieve an appropriate valve operation according to the engine speed, the cams driving the valves are designed. Variable valve lift (VVL) apparatuses in which the valves can operate at different lifts according to the engine speed have been developed.

The concept of cylinder deactivation (CDA) is similar to that of VVL. During CDA, some cylinders are deactivated when braking or running at a predetermined speed, and the fuel supply to the deactivated cylinders and the operation of the intake valves/exhaust valves are stopped.

A cross-sectional view of a conventional CDA device is shown in FIG. 1. A latching pin 50 restrains the movement of an outer body 10 and an inner body 20 by selectively moving left or right according to the oil supply. That is, the inner body 20 and the outer body 10 move up and down together when latched. But when unlatched, the inner body 20 and the outer body 10 move independently. The outer body 10 simply moves up and down, and cannot contribute to a valve lift due to a lost motion spring 40.

An anti-rotation pin 90 is formed in the conventional CDA device, and the anti-rotation pin 90 plays a role of reconciling a latching pin control oil hole and an oil hole of a cylinder head. However, there is a problem in that the anti-rotation pin 90 generates friction when the outer body moves.

Also, a stopper 95 is formed on the upper part of the outer body 10 in order to prevent the inner body 20 from rising excessively, and a retainer 80 and a lock 70 are needed because the lost motion spring 40 is equipped at the bottom of an upper seat 30.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention have been made in an effort to provide a direct acting cylinder deactivation (CDA) device with simplified structures to achieve optimal operations of the intake valves/exhaust valves according to the engine speed.

One aspect of the present invention is directed to a direct acting CDA device that may include an outer body glidingly contacting a cam and moving up and down, an upper seat located in the outer body and that is restricted to the movement of the outer body and an oil passage is formed between the outer body and the upper seat, and a latching device insertion hole is formed in a transverse direction in the oil passage, an inner body located in the upper seat, a latching device that is inserted in the latching device insertion hole and that selectively restricts the movement of the inner body to the movement of the outer body by selective oil supply, and a lost motion spring that is located in the hollow space of the upper seat and the inner body and is supported by the inner body and provides the outer body with an elastic force so that the outer body can selectively take a lost motion.

The latching devices according to various aspects of the present invention may be placed at both ends of the latching device insertion hole. They may include a latching pin that is inserted in the latching device insertion hole and selectively restricts the movement of the inner body, a latching spring that is located in the latching pin and provides the latching pin with an elastic force, and a plate supporting the latching spring. The end of the latching pin according to various aspects of the present invention may be formed with the same shape as the upper portion of the inner body, and the other end of the latching pin may be formed with a protrusion.

According to various aspects of the present invention, a groove may be formed at the outside of the outer body for oil supply, and an oil inlet may be formed at one side of the exterior circumference of the upper seat. An oil passage may be formed at the upper portion of the upper seat, through which the oil having flowed through the oil inlet can pass and the oil can be supplied into the latching device insertion hole.

One aspect of the direct acting CDA device according to the present invention may be characterized in that it can prevent a latching pin from rotating by forming the front shape of the latching pin into a shape corresponding to the contact portion of the inner body.

Another aspect of the direct acting CDA device according to the present invention may be characterized in that friction during the movement of the outer body can be reduced by forming a groove at one end of the exterior circumference and supplying oil through the groove.

Yet another of the direct acting CDA device according to the present invention may be characterized in that the structure of the direct acting CDA device can be simplified by placing the lost motion spring in the hollow space of the upper seat and the inner body.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of a conventional direct acting CDA device.

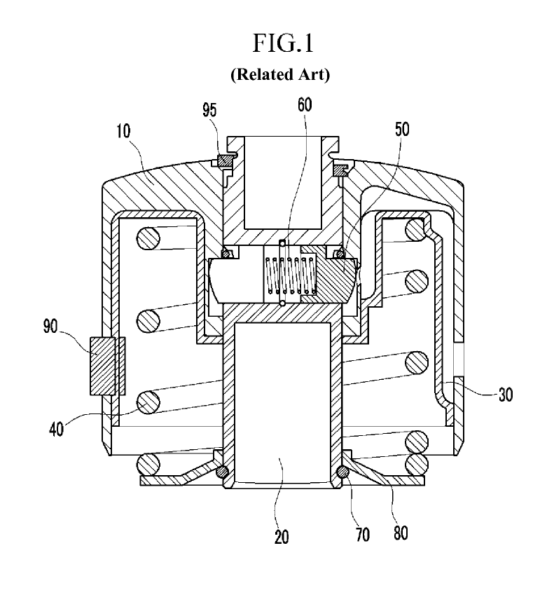

FIG. 2 is a cross-sectional view of an exemplary direct acting CDA device according to the present invention during latching.

FIG. 3 is a cross-sectional view of an exemplary direct acting CDA device according to the present invention during unlatching.

FIG. 4 is a perspective view of an exemplary direct acting CDA device according to the present invention.

FIG. 5 is a perspective view of an exemplary latching pin according to the present invention.

FIG. 6 is a perspective view of an exemplary upper seat according to the present invention.

FIG. 7 is a perspective view of an exemplary inner body according to the present invention.

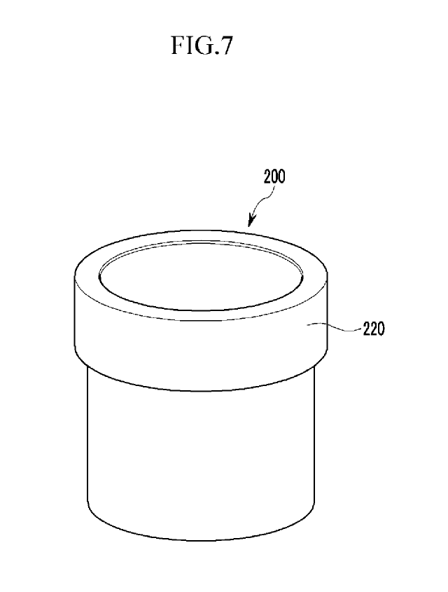

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Various embodiments of the direct acting CDA device according to the present invention include an outer body 100, which is a cylindrical hollow body that moves up and down according to the rotation of a cam while glidingly contacting the cam, and an upper seat 300 that is located in the outer body 100 and that is restricted to the movement of the outer body 100 and is closely fixed at the outer body 100.

The upper seat 300 has an oil passage 370 that is formed between the outer body 100 while maintaining air-tightness, and a latching device insertion hole 320 that is formed in a transverse line therein.

Various embodiments of the direct acting CDA device according to the present invention includes an inner body 200, a portion of which is located in the upper seat 300 and is selectively restricted to the movement of the outer body 100 by selective oil supply.

Also, various embodiments of the direct acting CDA device according to the present invention may include latching devices 400 that are inserted in both sides of the latching device insertion hole 320 formed at both insides of the upper seat 300 and selectively restricts the movement of the inner body 200 to the movement of the outer body 100 by selectively supplying oil into the oil passage 370.

Further, various embodiments of the direct acting CDA device according to the present invention may include a lost motion spring 500 that is located in the hollow space of the upper seat 300 and the inner body 200, is supported by the lower end of the inner body 200, and provides the outer body 100 with an elastic force so that the outer body 100 can selectively take a lost motion.

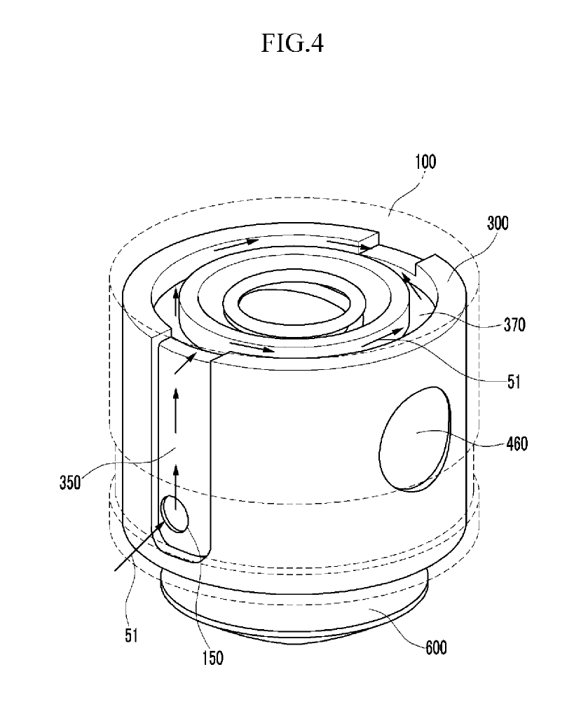

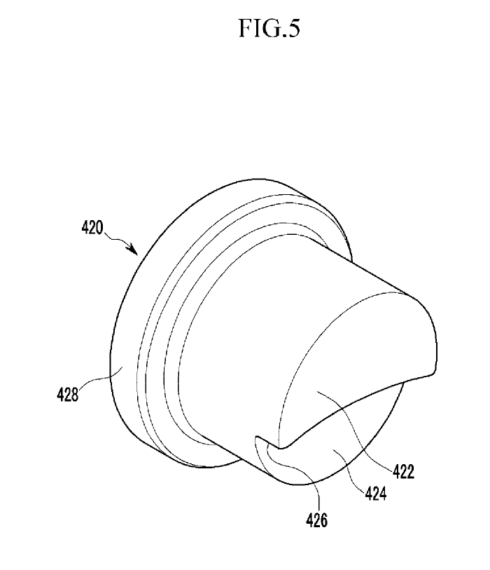

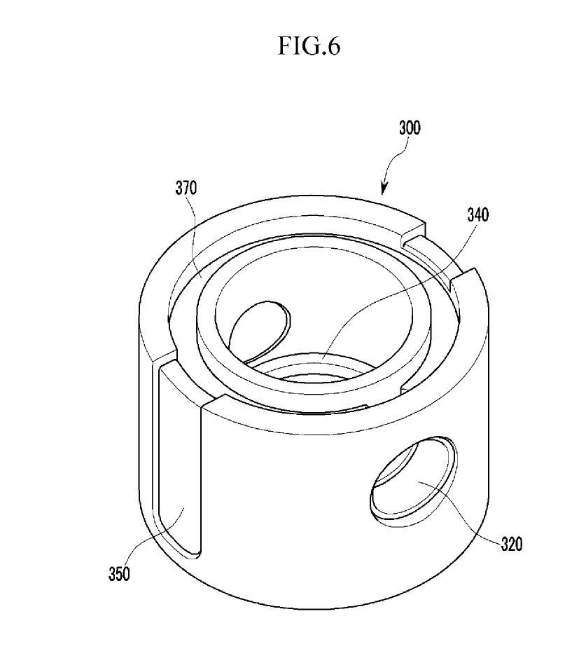

FIG. 4 shows a perspective view of a direct acting CDA device according to various embodiments of the present invention, wherein the outer body 100 is illustrated by a dotted line. A groove 150 is formed outside of the outer body 100 so that control oil for the latching pin 420 as shown in FIG. 5 can be supplied through the groove 150. An oil inlet 350, shown in FIG. 4 as well as in FIG. 6, is formed vertically at one side of the exterior circumference of the upper seat 300. In addition, an oil passage 370 is formed at the upper portion of the upper seat 300. The oil flowing in through the oil inlet 350 flows into the latching device insertion hole 320 after flowing through the oil passage 370. The flow of oil 51 is shown by the arrows.

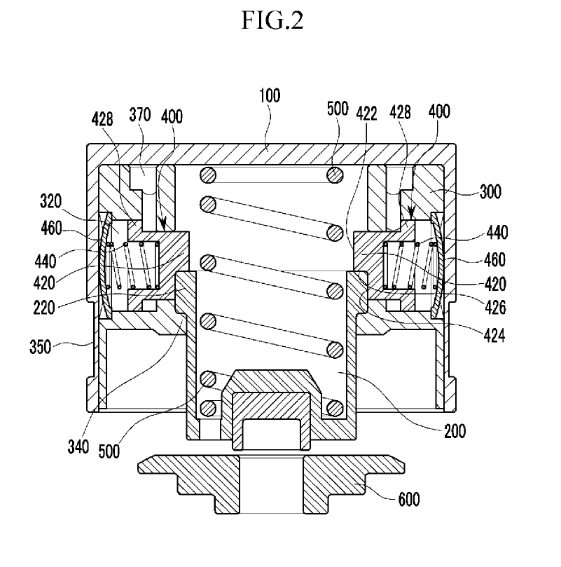

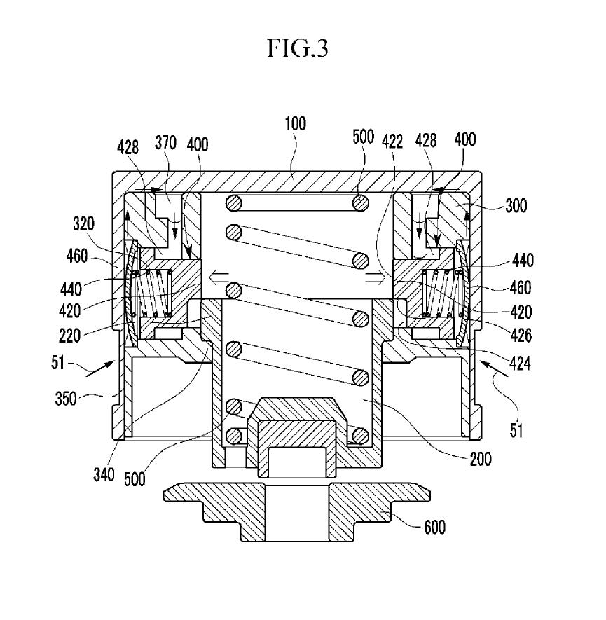

As shown in FIGS. 2-3, the latching device 400 includes a latching pin 420 that is inserted in the latching device insertion hole 320 and in which a hollow portion is formed and moves forward and backward by selective oil supply so that it can be restricted to the movement of the outer body 100, a latching spring 440 that is located inside the hollow portion and provides the latching pin 420 with an elastic force, and a plate 460 that supports the latching spring 440.

As shown in FIG. 5, a portion of the latching pin 420 contacting the inner body 200 is formed in a shape corresponding with the upper portion of the inner body 200 so that the latching pin 420 can be prevented from rotating, and a brim 428 is protruded at the other end of the latching pin 420.

Referring to FIG. 2 and FIG. 5, a sliding surface 422 of the front end of the latching pin 420 in which the inner body 200 glidingly moves up and down is rounded with the same shape as the shape of the outer body 100, and the latching pin 420 can be closely combined with a protrusion portion 220 of the inner body 200 by a vertical surface 424 of the latching pin and a horizontal surface 426 of the latching pin so that the latching pin 420 can be prevented from rotating, and the inner body 200 can be hung by an arrival portion 340.

Hereinafter, the operation processes according to various embodiments of the present invention will be described for a latching mode and an unlatching mode respectively.

First, referring to FIG. 2 for the latching mode scenario while oil is not supplied. The latching pin 420 is ready to move to approximately the center of the upper seat 300 by the elastic force resulting from the latching spring 440 formed in the latching pin 420.

When the outer body 100 moves down, the upper seat 300 moves down along with the outer body 100 pushing the latching pin 420 downward and inward. The lost motion spring 500 is pressed by the falling of the upper seat 300, and the latching pin 420 latches the inner body 200 so that the inner body 200 moves down along with the upper seat 300. That is, the inner body 200 moves down along with the outer body 100. At this moment, a valve 600 is pressed by the above process such that a valve lift occurs.

Secondly, referring to FIG. 3 for the unlatching mode. The oil 51 is supplied into the CDA device while unlatching. The oil 51 flows in through the groove 150 formed at the exterior circumference of the outer body 100, and the oil flows into the latching device insertion hole 320 after flowing through the oil passage 370 formed by the outer body 100 and the upper seat 300. The stream of the oil 51 is shown in FIG. 3 and FIG. 4 by the arrows. If the oil 51 flows into the latching device insertion hole 320, hydraulic pressure is generated in the latching device insertion hole 320 so that the latching pin 420 presses the latching spring 440 and moving outward.

In this case, the inner body is unlatched. The inner body 200 and the outer body 100 move up and down independently relative to each other. Although a cam moves up and down while glidingly contacting the outer body 100, the inner body 200 does not move. In other words, although the outer body 100 moves up and down, the inner body 200 does not move. As such, the CDA mode is achieved.

For convenience in explanation and accurate definition in the appended claims, the terms “upper” or “lower”, “front”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A direct acting cylinder deactivation (CDA) device comprising:
an outer body for glidingly contacting a cam to move up and down;
an upper seat with a hollow space, the upper seat located in the outer body and restricted to the movement of the outer body;
an oil passage formed between the outer body and the upper seat;
a latching device insertion hole formed in a transverse direction in the oil passage;
an inner body with a hollow space and a portion placed in the upper seat;
latching devices that are inserted in the latching device insertion hole; and
a lost motion spring that is located in the hollow spaces of the upper seat and the inner body and is supported by the inner body.

2. A direct acting CDA device of claim 1, wherein the latching devices are inserted at both ends of the latching device insertion hole.

3. A direct acting CDA device of claim 1, wherein the latching device comprises:
a latching pin inserted in the latching device insertion hole and selectively restricting the movement of the inner body;
a latching spring located in the latching pin and providing the latching pin with an elastic force; and
a plate supporting the latching spring.

4. A direct acting CDA device of claim 3, wherein the latching devices selectively restrict the movement of the inner body to the movement of the outer body by selective oil supply.

5. A direct acting CDA device of claim 3, wherein the latching pin has one end formed with the same shape as the upper portion of the inner body and the other end formed with a protrusion.

6. A direct acting CDA device of claim 1, wherein the outer body has a groove formed at the outside of the outer body.

7. A direct acting CDA device of claim 1, wherein the upper seat comprises:
an oil inlet formed at one side of the exterior circumference of the upper seat; and
an oil passage formed at the upper portion of the upper seat through which the oil having flowed through the oil inlet can pass and the oil can be supplied into the latching device insertion hole.

8. A direct acting CDA device of claim 1, wherein the lost motion spring provides the outer body with an elastic force so that the outer body can selectively take a lost motion.
